(19) United States
(12) Patent Application Publication
(10) Pub. No.: US 2009/0208386 A1
(43) Pub. Date: Aug. 20, 2009

(54) Germicidal water purification unit

(76) Inventors: Barry E. Barsky, Havertown, PA (US); Jay M. Silverman, Huntingdon Valley, PA (US)

Correspondence Address: ANDREW L. NEY, 4 ANDORRA HILL, LAFAYETTE HILL, PA, 19444, US

(21) Appl. No.: 11/977,107

(22) Filed: Oct. 23, 2007

(51) Int. Cl. B01J 19/08

(52) U.S. Cl. 422/186.3

(57) ABSTRACT

A germicidal water purification unit in which a plurality of light sources operating in the visible light frequency range or the ultraviolet frequency range are disposed along a conduit that carries water and radiate radially inward toward the axis of the conduit to kill microbiological pathogens present in the water.

### FIELD OF THE INVENTION

The present invention relates, in general, to water purification and, in particular, to a germicidal water purification unit that employs light sources operating in the visible light frequency range or the ultraviolet frequency range to kill microbiological pathogens present in the water.

### BACKGROUND OF THE INVENTION

It is well known that specific microbiological organisms that can be harmful or distasteful to consumers are present in water that is consumed in many homes and public places. Some of the known microbiological pathogens are:
Coliform bacteria are common in the environment and are generally not harmful. However, the presence of these bacteria in drinking water is usually a result of a problem with the treatment system or the pipes through which the water is distributed and indicates that the water might be contaminated with germs that can cause disease.
Fecal Coliform and E coli are bacteria the presence of which indicates that the water might be contaminated with human or animal wastes. Microbes in these wastes can cause short-term effects, such as diarrhea, cramps, nausea, headaches, or other symptoms of an underlying condition caused by a water supply borne pathogen.

Cryptosporidium is a parasite that enters lakes and rivers through sewage and animal waste and causes cryptosporidiosis which is a mild gastrointestinal disease. However, this disease can be severe or fatal for individuals with severely weakened immune systems. The Environmental Protection Agency and the Center for Disease Control have prepared advisories for those individuals with severely compromised immune systems who are concerned about Cryptosporidium.
Giardia lamblia is another parasite that enters lakes and rivers through sewage and animal waste. It causes gastrointestinal illness, such as diarrhea, vomiting, and cramps.

The efforts of the water departments of cities and suburban communities in purifying potable water are extensive and to be admired. However, more and more incidences of illnesses related to microbiological pathogens that escape normal germicidal treatments are being reported.

Consequently, many private and public facilities, such as office buildings, factories, and sports arenas, are equipped with a germicidal water purification system that typically is installed in proximity to the point at which the water enters the facility. As a result, all consumers of water in the facility consume water that has passed through the germicidal water purification system. Light sources that operate in the visible light frequency range or the ultraviolet frequency range are commonly used to kill microbiological pathogens present in the water.

Typically, such germicidal water purification systems are arranged with the light sources disposed within the conduit through which the water passes. Such arrangements, for the most part, can be difficult to service and maintain and can result in inconvenience to the consumers of water in the facilities where the water purification systems are installed. With the light sources disposed in the water flow, leakage of water into the light sources is a concern. In addition, the supply of water necessarily is interrupted when the light sources are to be serviced or replaced.

### SUMMARY OF THE INVENTION

A germicidal water purification unit, constructed in accordance with the present invention, includes a housing and a conduit extending within the housing axially of the housing and having an inlet end through which water is introduced to the germicidal water purification unit and an outlet end through which the water is conducted away from the germicidal water purification unit. A plurality of light sources, operating in at least one of the visible light frequency range and the ultraviolet frequency range, is disposed along the conduit radially outward from the axis of the conduit. Power supply means supply power to the light sources to energize the light sources.

### BRIEF DESCRIPTION OF THE DRAWINGS

FIG. 1 is a side view, partially in section, of a first embodiment of a germicidal water purification unit constructed in accordance with the present invention.

FIG. 2 is a side view, partially in section, of a second embodiment of a germicidal water purification unit constructed in accordance with the present invention.

FIG. 3 is a sectional view, taken along line 3-3 of FIG. 1, of an array of light sources used in the FIG. 1 embodiment of the present invention.

FIG. 4 is a sectional view, taken along line 4-4 of FIG. 2, of an array of light sources used in the FIG. 2 embodiment of the present invention.

FIG. 5 is a diagram of a circuit for selective activation of the power supply of the present invention.

FIG. 6 is a perspective view, partially in section, of a third embodiment of a germicidal water purification unit constructed in accordance with the present invention.

FIG. 6A is a perspective view of the water conduit of the FIG. 6 embodiment of a germicidal water purification unit constructed in accordance with the present invention.

FIG. 6B is a perspective view, partially in section, of the FIG. 6A water conduit.

FIG. 6C is an exploded perspective view, partially in section, of the FIG. 6 embodiment of a germicidal water purification unit constructed in accordance with the present invention.

### DETAILED DESCRIPTION OF THE INVENTION

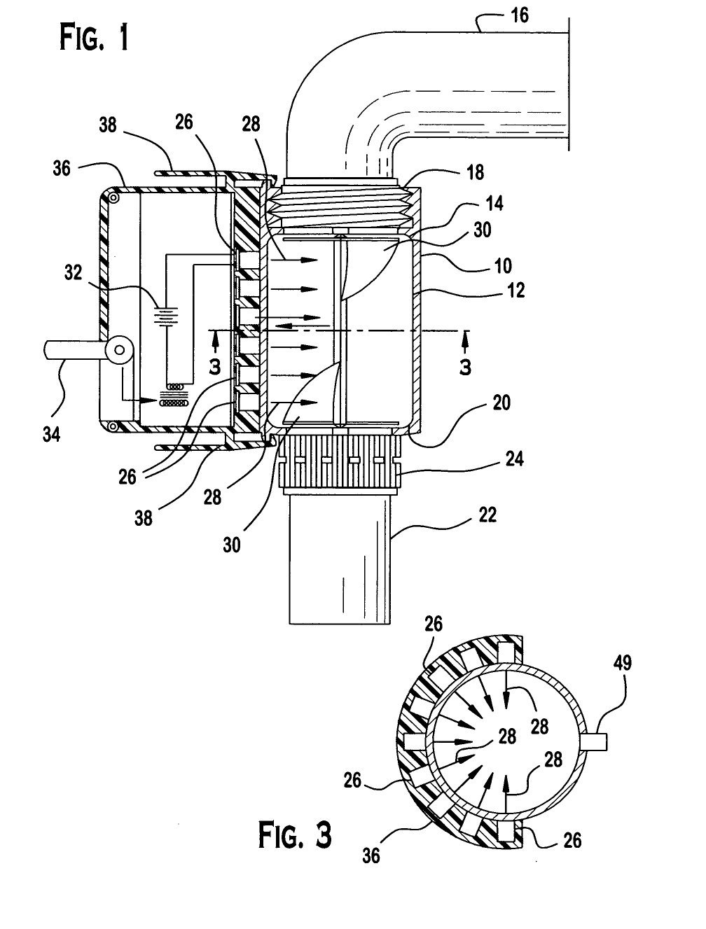

Referring to FIG. 1, a germicidal water purification unit, constructed in accordance with the present invention, includes a housing 10. A conduit 12 extends within housing 10 axially of the housing. Conduit 12 has an inlet end 14 connected to a water delivery pipe 16 by suitable means, such as a threaded coupling 18. For the FIG. 1 embodiment of the present invention, water delivery pipe 16 is a water faucet of conventional construction and operation, with water flow controlled by a control knob (not shown) in the usual manner. Water is introduced to the germicidal water purification unit from faucet 16 through threaded coupling 18 at inlet end 14 of conduit 12. Conduit 12 has an outlet end 20 at which a water discharge port 22 is connected to conduit 12 by suitable means, such as a coupling 24. Water is conducted away from the germicidal water purification unit through water discharge port 22 and coupling 24 at outlet end 20 of conduit 12.

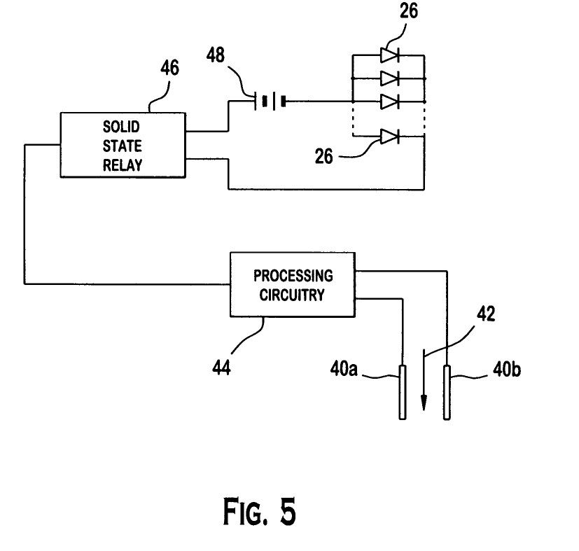

A germicidal water purification unit, constructed in accordance with the present invention, also includes a plurality of light sources 26 of conventional construction and operation that operate in either the visible light frequency range or the ultraviolet frequency range. Light sources 26 are disposed along conduit 12 radially outward from the axis of the conduit. In the FIG. 1 embodiment of the present invention, light sources 26 are mounted in housing 10, recessed from the inner surface of conduit 12, and only partially surround the conduit for example, in semicircular arrays as illustrated in FIG. 3. Arrows 28 in FIGS. 1 and 3 indicate radiations from light sources 26. LED's, available from Opto Technology, Inc., operating in the visible light range or at 253.7 nanometers in the ultraviolet light range can serve as the light sources 26.

Preferably, a germicidal water purification unit, constructed in accordance with the present invention, further includes means within conduit 12 for impeding water flow through the conduit. As illustrated in FIG. 1, such means can take the form of fins 30, disposed along the axis of conduit 12, that increase the path of water flow through the conduit and the time of exposure of the water to radiation from light sources 26. To further increase the effectiveness of the radiations from light sources 26, a reflector formed, for example, of a polymer with a reflective aluminum surface can be inserted in conduit 12 or applied to the inside surface of the conduit or the means for impeding water flow through conduit 12 can be made, for example, of a polymer with a reflective aluminum surface. In this way, the water passing through conduit 12 is exposed to an increase in the radiation from light sources 26.

A germicidal water purification unit, constructed in accordance with the present invention, also includes power supply means for supplying power to light sources 26 to energize the light sources. As illustrated in FIG. 1, the power supply means can be a rechargeable battery 32 that is charged when a male plug 34 is inserted into a power source such as a wall outlet. It will be apparent that alternative power sources can serve to power light sources 26.

As illustrated in FIG. 1, light sources 26 and the power supply means are positioned in a second housing 36 that is detachably secured to housing 10 by clamping members 38. This option of a separable housing that contains the power supply means may be preferred, under certain circumstances, to a permanently connected power cord that can create a hazardous condition when the power cord is in close proximity to water passing through conduit 12 and discharged from water discharge port 22. Positioning a rechargeable battery in a separable housing permits removal of the power supply means for recharging the battery at a remote location.

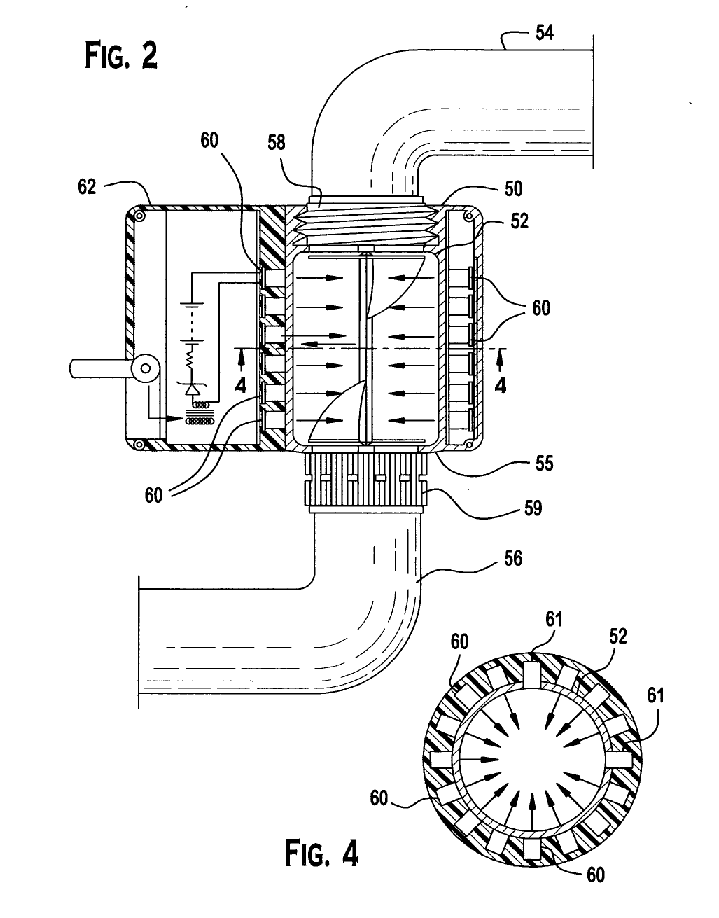

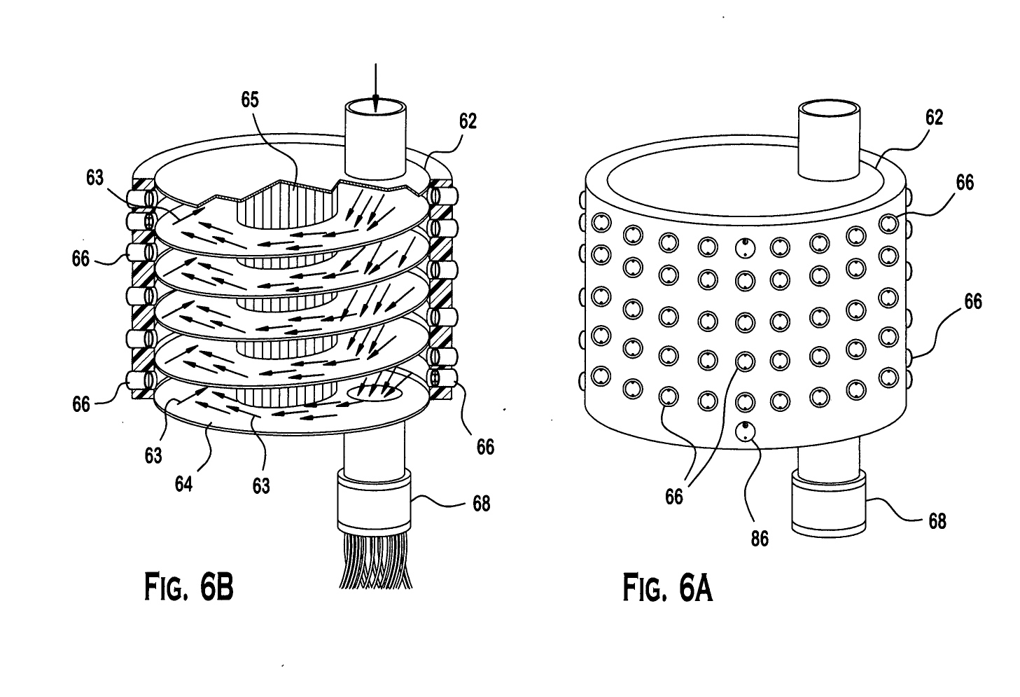

In FIG. 5, which illustrates a circuit for selective activation of the power supply means of the FIG. 1 and FIG. 2 embodiments of the present invention, a flow sensor, in the form of a pair of capacitance plates 40a and 40b, for example, senses the passage of water through inlet end 14 of conduit 12 as represented by an arrow 42. A signal, representative of water flow, is conducted from the flow sensor to processing circuitry 44 of conventional construction and operation to produce a control signal that closes a solid state relay 46 to connect a battery 48 to light sources 26. In this way, light sources 26 are powered on an as needed basis, thereby resulting in savings in energy costs and lengthening the useful life of the light sources. It will be understood that the various other flow sensors (for example, optical, electrical, or mechanical) can be used.

FIG. 2 illustrates a second embodiment of a germicidal water purification unit constructed in accordance with the present invention. Although the second embodiment differs from the FIG. 1 embodiment, it should be understood that certain components or features that are included in one of the embodiments can be incorporated in the other or substituted for like components and features in the other.

The germicidal water purification unit of FIG. 2 is arranged for insertion into the water line at a point between entry of the water into the water system and the point at which the water is actually consumed. One example is locating the germicidal water purification unit beneath a sink. In such an application, an inlet end 50 of a conduit 52 is adapted for connection to a first section 54 of a water delivery system and an outlet end 55 of the conduit is adapted for connection to a second section 56 of the water delivery system. In FIG. 2, the connection of conduit 52 to first section 54 is by a threaded coupling 58 at inlet end 50 of the conduit and the connection of the conduit to second section 56 is by a coupling 60 at outlet end.

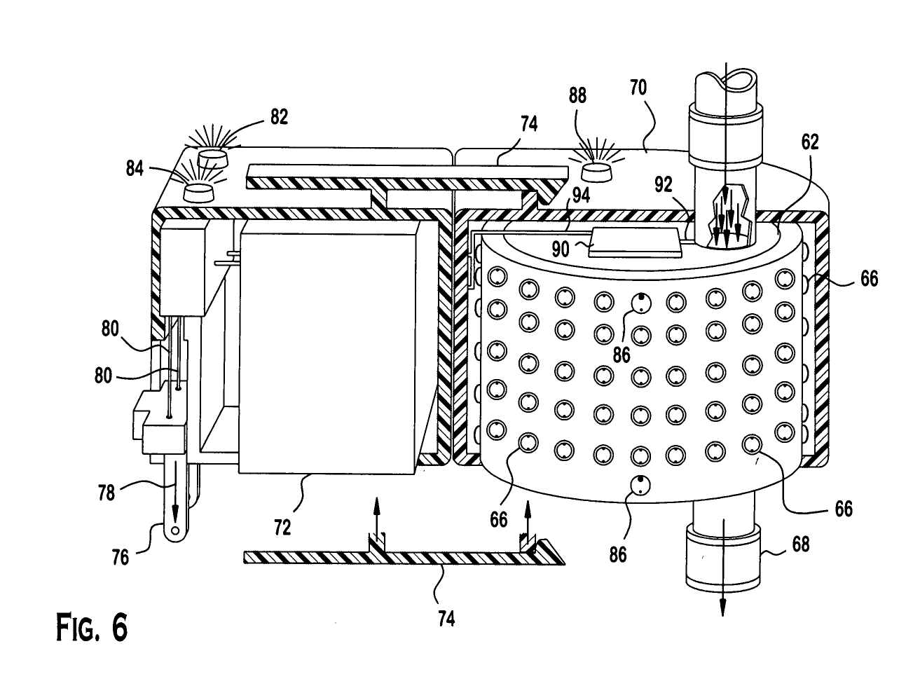

In the FIG. 2 embodiment of the present invention, light sources 60 completely surround conduit 52 as illustrated in FIG. 4. In addition, all of the components are contained in a single housing 62.

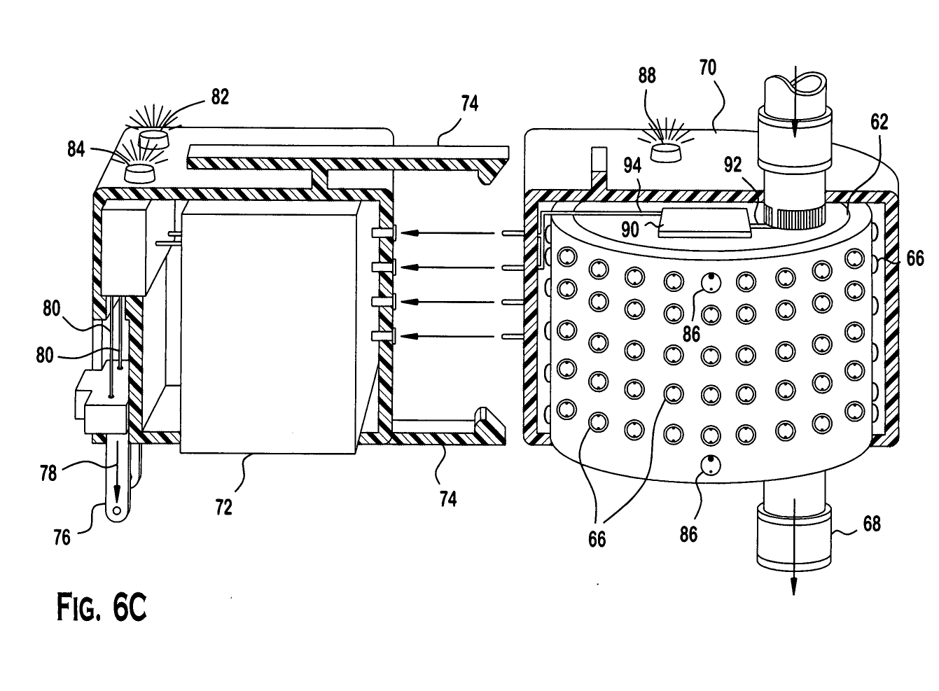

Referring to FIGS. 6 and 6A through 6C, this embodiment of a germicidal water purification unit, constructed in accordance with the present invention, is generally similar in construction and operation to the first two embodiments. Among the differences are the means for impeding water flow through conduit 62. As illustrated in FIG. 6B, water flow through conduit 62, represented by arrows 63, is impeded by a spiral structure 64, mounted on a column 65 that forms a helical passage through conduit 62, that increases the path of water flow through the conduit and the time of exposure of the water to radiation from light sources 66 mounted in the conduit. It will be apparent that spiral structure 64 can be substituted for fins 30 in the first two embodiments of the present invention and that fins 30 can be substituted for spiral structure 64 in the third embodiment of the present invention. Also, spiral structure 64 can be formed with a reflective aluminum surface, as are the means for impeding water flow through conduit 12 in FIG. 1, to increase the exposure of the water flow through conduit 62 to the radiation from light sources 66.

The germicidal water purification unit illustrated in FIGS. 6 and 6A through 6C also includes an aerator 68 that produces uniform water flow and results in water conservation. Aerator 68 may be of conventional construction and operation, such as the aerators that are commonly attached to water faucets at the present time. It will be apparent that an aerator can be included in the first two embodiments of the present invention illustrated in FIGS. 1 and 2 and described above.

The FIGS. 6 and 6A through 6C embodiment of the present invention is arranged for detachment of the power supply means from housing 70, within which water conduit 62 is positioned, to permit charging of a rechargeable battery when plugged into a power source at a remote location. This is shown most clearly in FIG. 6C. In particular, a power supply means housing 72, within which a rechargeable battery is located, is detachably secured to housing 70 by clamping members 74. A mail plug 76, shown in FIGS. 6 and 6C in an extended position as indicated by arrow 78, is connected to the rechargeable battery by a pair of flexible wires 80 that collapse to accommodate retraction of the male plug, in a direction opposite to arrow 78, after the battery has been charged as indicated by illumination of an indicator light source 82. Blinking illumination of a second indicator light source 84 indicates that the charge of the rechargeable battery is low and that the rechargeable battery should be recharged.

Also mounted in conduit 62 are light detectors 86 that determine the real time emission level of light sources 66. A third indicator light source 88, responsive to light detectors 86, illuminates when the emission level of light sources 66 drops below a prescribed level, signifying that the rechargeable battery should be recharged. Light detectors, available from Denicom Co., Ltd., can be used as light detectors 86.

As indicated by reference numerals 49 and 61 in FIG. 3 and FIG. 4, respectively, the feature of determining the real time emission level of light sources 26 and 60, respectively, can be incorporated in the first and second embodiments of the present invention.

As indicated by reference numeral 90 in FIGS. 6 and 6C, which represents processing circuitry 44 in FIG. 5, the feature for selectively activating the power supply can be incorporated in the third embodiment of the present invention. A signal, representative of water flow, is conducted to processing circuitry 90 via wires 92 and the control signal produced by the processing circuitry is conducted from the processing circuitry via wires 94.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A germicidal water purification unit comprising:
a housing;
a conduit extending within said housing axially of said housing and having an inlet end through which water is introduced to the germicidal water purification unit and an outlet end through which the water is conducted away from the germicidal water purification unit;
a plurality of light sources operating in at least one of the visible light frequency range and the ultraviolet frequency range and disposed along said conduit radially outward from the axis of said conduit; and
power supply means for supplying power to said light sources to energize said light sources.

2. A germicidal water purification unit according to claim 1 wherein said light sources are recessed from the inner surface of said conduit.

3. A germicidal water purification unit according to claim 2 wherein said inlet end of said conduit is adapted for connection to a faucet.

4. A germicidal water purification unit according to claim 2 wherein said germicidal water purification unit is adapted for installation in a water delivery system with said inlet end of said conduit is adapted for connection to a first section of said water delivery system and said outlet end of said conduit is adapted for connection to a second section of said water delivery system.

5. A germicidal water purification unit according to claim 3 wherein said light sources completely surround said conduit.

6. A germicidal water purification unit according to claim 3 wherein said light sources partially surround said conduit.

7. A germicidal water purification unit according to claim 4 wherein said light sources completely surround said conduit

8. A germicidal water purification unit according to claim 4 wherein said light sources partially surround said conduit.

9. A germicidal water purification unit according to claim 5 further including a second housing:
(a) detachably secured to said housing through which said conduit extends, and
(b) in which said power supply is located.

10. A germicidal water purification unit according to claim 6 further including a second housing:
(a) detachably secured to said housing through which said conduit extends, and
(b) in which said power supply is located.

11. A germicidal water purification unit according to claim 5 further including means within said conduit for impeding water flow through said conduit.

12. A germicidal water purification unit according to claim 6 further including means within said conduit for impeding water flow through said conduit.

13. A germicidal water purification unit according to claim 7 further including means within said conduit for impeding water flow through said conduit.

14. A germicidal water purification unit according to claim 8 further including means within said conduit for impeding water flow through said conduit.

15. A germicidal water purification unit according to claim 11 wherein said power supply means include:
(a) a power supply, and
(b) means for sensing the passage of water through said inlet end of said conduit to energize said light sources by said power supply.

16. A germicidal water purification unit according to claim 12 wherein said power supply means include:
(a) a power supply, and
(b) means for sensing the passage of water through said inlet end of said conduit to energize said light sources by said power supply.

17. A germicidal water purification unit according to claim 13 wherein said power supply means include:
(a) a power supply, and
(b) means for sensing the passage of water through said inlet end of said conduit to energize said light sources by said power supply.

18. A germicidal water purification unit according to claim 14 wherein said power supply means include:
(a) a power supply, and
(b) means for sensing the passage of water through said inlet end of said conduit to energize said light sources by said power supply.

19. A germicidal water purification unit according to claim 13 further including means for sensing the light emission level of said light sources.

20. A germicidal water purification unit according to claim 14 further including means for sensing the light emission level of said light sources.

21. A germicidal water purification unit according to claim 13 wherein said means within said conduit for impeding water flow through said conduit include fins disposed along the axis of said conduit.

22. A germicidal water purification unit according to claim 14 wherein said means within said conduit for impeding water flow through said conduit include fins disposed along the axis of said conduit.

23. A germicidal water purification unit according to claim 13 wherein said means within said conduit for impeding water flow through said conduit include a spiral structure mounted on a column within said conduit that forms a helical passage through said conduit.

24. A germicidal water purification unit according to claim 14 wherein said means within said conduit for impeding water flow through said conduit include a spiral structure mounted on a column within said conduit that forms a helical passage through said conduit.
